(19) United States
(12) Patent Application Publication
(10) Pub. No.: US 2015/0136704 A1
(43) Pub. Date: May 21, 2015

(54) METHOD AND APPARATUS FOR TREATING WASTEWATER CONTAINING RADIOACTIVE STRONTIUM

(71) Applicants: KURITA WATER INDUSTRIES LTD., Nakano-ku, Tokyo (JP); OTSUKA CHEMICAL CO., LTD., Osaka-shi, Osaka (JP)

(72) Inventors: Koichi Mori, Nakano-ku (JP); Satoshi Yamada, Nakano-ku (JP); Nobuki Itoi, Tokushima-shi (JP); Hiroyoshi Mori, Tokushima-shi (JP); Toshiki Gotou, Tokushima-shi (JP)

(21) Appl. No.: 14/403,044

(22) PCT Filed: May 21, 2013
(86) PCT No.: PCT/JP2013/064026

§ 371 Date: Nov. 21, 2014

(30) Foreign Application Priority Data
May 29, 2012 (JP) 2012-122214

(51) Int. Cl. C02F 9/00

(52) U.S. Cl. CPC C02F 9/00; C02F 2101/006
USPC 210/665; 210/682; 210/219

(57) ABSTRACT

Radioactive strontium is efficiently removed from wastewater containing radioactive strontium. In a treatment method for radioactive strontium-containing wastewater, wastewater containing radioactive strontium and a powdery alkali metal titanate are mixed in a stirrer-equipped reaction tank by stirring such that radioactive strontium in the wastewater is adsorbed on the powdery alkali metal titanate, followed by subjecting the powdery alkali metal titanate having radioactive strontium adsorbed thereon to solid-liquid separation. The radiation dose of treated water can be effectively reduced in such a manner that a powder of an alkali metal titanate is directly added to radioactive strontium-containing wastewater and is dispersed therein and therefore radioactive strontium is efficiently removed by adsorption.

### FIELD OF INVENTION

The present invention relates to a method and apparatus for efficiently removing radioactive strontium from wastewater containing radioactive strontium.

### BACKGROUND OF INVENTION

Radioactive strontium ⁹⁰Sr, as well as radioactive cesium, has a long half-life and is a fission product highly diffusible in water; hence, it is desired to improve a technique for efficiently removing radioactive strontium from water contaminated with radioactive strontium.

A method for removing radioactive strontium by adsorption using an adsorbent containing orthotitanic acid has been known as a method for treating wastewater containing radioactive strontium (Non Patent Literature 1). A method using sodium titanate in the form of granules as such an adsorbent has been proposed (Patent Literature 1).

### LIST OF LITERATURE

### Patent Literature

Patent Literature 1: Japanese Patent 4428541

### Non Patent Literature

Non Patent Literature 1: Masumitsu Kubota et al., Development of group separation method: Development of treating method of liquid waste containing 90Sr and 134Cs by inorganic ion exchange column), JAERI-M 82-144 (1982)

### OBJECT AND SUMMARY OF INVENTION

### Object of Invention

As described in Patent Literature 1, it is difficult to ensure sufficient crushing strength in the case of granulizing an alkali metal titanate only. Therefore, in the case of removing strontium by adsorption in such a manner that wastewater is fed through an adsorption column filled with granules of the alkali metal titanate, fine particles generated from surfaces of the crushed granules flow out of an outlet of the adsorption column and, as a result, it is difficult to stably ensure the DF (decontamination factor) value for radioactive strontium in treated water.

Supporting the alkali metal titanate on substrates having sufficient strength as filler increases radioactive waste by an amount equal to the amount of the substrates, which are inert. Furthermore, alkali metal titanate-supported granules need to be produced and therefore costs increase.

In the case of treating wastewater containing a high concentration of strontium, a large amount of the alkali metal titanate, which is an expensive functional material, has needed to be used. In the case where seawater in which calcium and magnesium, which are the same alkaline-earth metals, are co-present with strontium has been contaminated with radioactive strontium, a larger amount of the alkali metal titanate has needed to be used because the alkali metal titanate adsorbs calcium and magnesium together with strontium.

A method in which strontium in wastewater is precipitated in the form of a carbonate and is then removed by solid-liquid separation need not use any special functional material, is a method effective in roughly removing strontium present at high concentration, and has had a problem that strontium cannot be removed to a level not higher than the solubility of strontium.

The present invention has a first object to provide a treatment method and treatment apparatus for efficiently removing radioactive strontium from wastewater containing radioactive strontium.

The present invention further has a second object to provide a treatment method and treatment apparatus for efficiently removing radioactive strontium from wastewater containing an alkaline-earth metal in addition to radioactive strontium like high-concentration radioactive strontium-containing wastewater and seawater contaminated with radioactive strontium.

### Solution to Problem

The inventors have performed intensive investigations to solve the above problems and, as a result, have found that the radiation dose of treated water can be effectively reduced in such a manner that a powder of an alkali metal titanate is directly added to radioactive strontium-containing wastewater and is dispersed therein and therefore radioactive strontium is efficiently removed by adsorption.

Furthermore, the inventors have found that strontium and other alkaline-earth metals in wastewater are allowed to react with carbonate ions under alkaline conditions prior to or in parallel with the treatment thereof, precipitates are thereby produced, and these can be readily removed by solid-liquid separation.

The present invention has been accomplished on the basis of these findings and is as summarized below.

[1] A method for treating radioactive strontium-containing wastewater, comprising: a step of mixing wastewater containing radioactive strontium with a powdery alkali metal titanate in a stirrer-equipped reaction tank to allow the powdery alkali metal titanate to adsorb radioactive strontium in the wastewater; and a step of subjecting the powdery alkali metal titanate on which radioactive strontium is adsorbed to solid-liquid separation.
[2] The method for treating radioactive strontium-containing wastewater according to [1], wherein an alkali metal of the powdery alkali metal titanate is sodium and/or potassium.
[3] The method for treating radioactive strontium-containing wastewater according to [1] or [2], wherein the powdery alkali metal titanate has an average particle size of 1 μm to 1,000 μm, and has a non-fibrous in which a plurality of bumps having a round tip extend in irregular directions.
[4] The method for treating radioactive strontium-containing wastewater according to any one of [1] to [3], wherein the powdery alkali metal titanate is used in the form of slurry.
[5] The method for treating for radioactive strontium-containing wastewater according to any one of [1] to [4], wherein the method further comprises an alkali aggregation step for depositing strontium in the wastewater in such a manner that carbonate ions are added to the wastewater in an amount equivalent to 1.0 to 2.0 times the amount of strontium contained in the wastewater, and alkali is then further added to the wastewater such that the pH thereof is adjusted to 9.0 to 13.5; and wherein the powdery alkali metal titanate is added during the alkali aggregation step or after the alkali aggregation step.
[6] The method for treating radioactive strontium-containing wastewater according to any one of [1] to [4], wherein the wastewater contains an alkaline-earth metal other than strontium, wherein the method further comprises an alkali aggregation step for depositing strontium and the alkaline-earth metal other than strontium in the wastewater in the form of carbonates or hydroxides in such a manner that carbonate ions are added in an amount equivalent to 1.0 to 2.0 times the amount of all the alkaline-earth metals in the wastewater, and alkali is further added such that the pH thereof is adjusted to 9.0 to 13.5; and wherein the powdery alkali metal titanate is added during the alkali aggregation step or after the alkali aggregation step.
[7] An apparatus for treating radioactive strontium-containing wastewater, comprising: a stirrer-equipped reaction tank; means for introducing radioactive strontium-containing wastewater into the reaction tank; means for adding a powdery alkali metal titanate to the reaction tank; and solid-liquid separation means for subjecting a reaction solution coming from the reaction tank to solid-liquid separation, wherein the powdery alkali metal titanate is added to the radioactive strontium-containing wastewater in the reaction tank, radioactive strontium in the wastewater is adsorbed on the powdery alkali metal titanate, and the powdery alkali metal titanate having radioactive strontium adsorbed thereon is separated with the solid-liquid separation means.
[8] The apparatus for treating radioactive strontium-containing wastewater according to [7], wherein the apparatus further comprises means for adding a carbonate to the reaction tank and means for adjusting the pH in the reaction tank.
[9] The treatment apparatus for radioactive strontium-containing wastewater according to [7], wherein the apparatus further comprises a first reaction tank in which a carbonate and alkali are added to the wastewater, the first reaction tank being located upstream of the stirrer-equipped reaction tank so that an outflow from the first reaction tank is introduced into the stirrer-equipped reaction tank.
[10] The apparatus for treating radioactive strontium-containing wastewater according to any one of [7] to [9], wherein the solid-liquid separation means is a settling tank or an ultrafiltration membrane separator.

According to the present invention, the radiation dose of treated water can be effectively reduced in such a manner that a powder of an alkali metal titanate is directly added to radioactive strontium-containing wastewater and is dispersed therein and therefore radioactive strontium is efficiently removed by adsorption.

In the case where the concentration of radioactive strontium in wastewater is high or in the case where wastewater contains an alkaline-earth metal other than radioactive strontium like seawater is contaminated with radioactive strontium, strontium and the alkaline-earth metal in the wastewater are allowed to react with carbonate ions under alkaline conditions prior to or in parallel with treatment using a powder of an alkali metal titanate and are deposited and the concentrations in the wastewater are thereby reduced. Thereafter or in conjunction therewith, adsorption treatment is performed using a powdery alkali metal titanate, whereby efficient treatment can be performed using a small amount of the powdery alkali metal titanate even in the treatment of high-concentration radioactive strontium-containing wastewater, radioactive strontium-contaminated seawater containing other alkaline-earth metals, or the like.

### BRIEF DESCRIPTION OF DRAWINGS

FIG. 1 is a flow diagram showing an embodiment of a treatment apparatus for radioactive strontium-containing wastewater according to the present invention.

FIG. 2 is a flow diagram showing another embodiment of a treatment apparatus for radioactive strontium-containing wastewater according to the present invention.

FIG. 3 is a flow diagram showing another embodiment of a treatment apparatus for radioactive strontium-containing wastewater according to the present invention.

FIG. 4 is a flow diagram showing another embodiment of a treatment apparatus for radioactive strontium-containing wastewater according to the present invention.

FIG. 5 is a SEM photograph of potassium dititanate.

### DESCRIPTION OF EMBODIMENTS

Embodiments of the present invention are described below in detail. The embodiments described below are intended to facilitate the understanding of the present invention and are not intended to limit the present invention. The present invention can be carried out in such a manner that elements disclosed in the embodiments below are variously modified without departing from the scope of the present invention.

In the present invention, a powdery alkali metal titanate is added to a radioactive strontium-containing wastewater (hereinafter referred to as “raw water” in some cases) and is mixed in a reaction tank by stirring such that the wastewater and the powdery alkali metal titanate are subjected to solid-liquid contacting, whereby radioactive strontium in the wastewater is adsorbed on the powdery alkali metal titanate and is removed. Thereafter, the powdery alkali metal titanate having radioactive strontium adsorbed thereon is subjected to solid-liquid separation, whereby treated water from which radioactive strontium has been highly removed can be obtained.

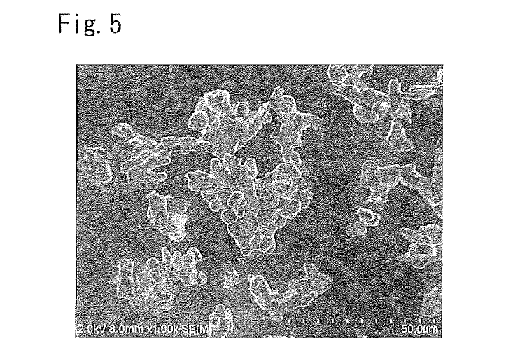

An alkali metal of the alkali metal titanate used in the present invention is preferably sodium and/or potassium in terms of the ability to adsorb strontium and particularly preferably potassium dititanate and potassium tetratitanate from the viewpoint of adsorption rate and adsorption capacity. Furthermore, in the case of synthesizing potassium dititanate or potassium tetratitanate by a common fusion process, a product with a fibrous crystal shape is obtained. However, a product having such a shape that a plurality of bumps with a round tip extend in irregular directions is obtained in such a manner that after a titanium source and a potassium source are mixed while being mechanochemically crushed, the crushed mixture is calcined at 650° C. to 1,000° C. as disclosed in WO 2008/123046 (FIG. 5). Potassium titanate with such a shape does not damage any filtration membrane as compared to a fibrous product and is preferred in terms of filtration properties.

When a solid alkali metal titanate, for example, potassium dititanate, is contacted with strontium ions in the raw water, an ion exchange reaction given by Expression (1) below proceeds depending on the difference in stability between a potassium salt and a strontium salt. This removes strontium from the raw water.

K₂O.2TiO₂+Sr²⁺→SrO.2TiO₂+2K⁺ (1)

The powdery alkali metal titanate, which is added to wastewater, preferably has an average particle size of 1 μm to 1,000 μm, particularly preferably 1 μm to 100 μm, and especially preferably 5 μm to 50 μm. When the average particle size of the powdery alkali metal titanate is excessively small, the handleability thereof is poor. When the average particle size is excessively large, the specific surface area is small and the ability to adsorb radioactive strontium tends to decrease. The average particle size can be measured with, for example, a laser diffraction particle size distribution analyzer.

The powdery alkali metal titanate, which is used in the present invention, is preferably one represented by the chemical formula M₂Ti₂O₆ (M: an alkali metal ion) because it has a large cation exchange capacity, is thermally stable, and is excellent in resistance to chemicals such as acids and alkalis.

A single type of alkali metal titanate may be used alone or two or more types of alkali metal titanates containing different alkali metals or having different properties may be used in combination.

The powdery alkali metal titanate may be dry-supplied to the raw water in the form of powder using a quantitative powder feeder. The powdery alkali metal titanate is stored in a tank in the form of slurry in advance and may be wet-supplied to the raw water using a pump. In the case of slurry, the following method is preferably used: a method in which slurry is supplied while being circulated in such a manner that a stirrer is used or a circulation line is connected to a discharge line of a supply pump such that sedimentation does not occur in a storage tank. As a solvent for slurry, water or an aqueous solution containing alkali metal ions can be used and the alkali metal ion-containing aqueous solution is preferably used because the powdery alkali metal titanate can be prevented from being transformed into an H-type having the low ability to adsorb strontium. In the case of supplying the powdery alkali metal titanate in the form of slurry, the concentration of the powdery alkali metal titanate in the slurry is preferably about 1% to 50% by weight in terms of handling.

The powdery alkali metal titanate may be added in the form of granular aggregates as described in Patent Literature 1. In this case, the aggregates preferably have an average particle size of about 10 μm to 1,000 μm and more preferably about 10 μm to 250 μm.

The amount of the powdery alkali metal titanate added to the raw water varies depending on properties of the raw water and whether treatment using a carbonate below is performed and is preferably 50 mg to 5,000 mg per liter of the raw water. When the amount of the added powdery alkali metal titanate is excessively small, radioactive strontium in the raw water cannot be sufficiently removed. When the amount thereof is excessively large, a higher removal effect cannot be expected and the amount of the powdery alkali metal titanate used is unnecessarily large, which is uneconomical.

In usual, the adsorption treatment of radioactive strontium by means of the powdery alkali metal titanate is preferably performed under conditions at a pH of about 7 to 13. Thus, when the pH of the raw water is outside the above range, the pH thereof is appropriately adjusted by adding acid or alkali.

After the powdery alkali metal titanate is added to the raw water, mixing is sufficiently performed in a stirrer-equipped reaction tank by stirring for the purpose of ensuring the necessary reaction time. In usual, the reaction time is preferably about 1 minute to 120 minutes and therefore the stirrer-equipped reaction tank is preferably designed such that such a residence time is achieved.

After the powdery alkali metal titanate is added to the raw water in the stirrer-equipped reaction tank and is allowed to sufficiently react therewith, a reaction solution is subjected to solid-liquid separation. In this operation, coagulation treatment may be performed by adding a coagulant as required. An anionic polymer or the like can be used as the coagulant as described below and the amount of the added coagulant is usually about 0.5 mg/L to 5 mg/L.

Solid-liquid separation can be performed using a settling tank, an MF (microfiltration) membrane separator, or the like.

Treated water in which the concentration of radioactive strontium is reduced to 1 mg/L or less can be usually obtained by such treatment.

In the present invention, when the raw water contains radioactive strontium and a large amount, for example, 3 mg/L or more, of alkaline-earth metals (including strontium, which is a stable isotope), an attempt to remove radioactive strontium by adsorption in such a manner that the powdery alkali metal titanate is directly added to the raw water is economically disadvantageous because the added powdery alkali metal titanate is used for the alkaline-earth metals rather than radioactive strontium and therefore a large amount of the powdery alkali metal titanate is necessary.

Thus, in the case of treating the raw water, it is preferred that radioactive strontium and the alkaline-earth metals in the raw water are deposited or precipitated by adding a carbonate to the raw water under alkaline conditions (this operation is hereinafter referred to as “alkali aggregation” in some cases) and the adsorption treatment of radioactive strontium is performed by adding the powdery alkali metal titanate after or in parallel with this treatment.

According to alkali aggregation, ions of the alkaline-earth metals, such as calcium, strontium, and magnesium, dissolved in the raw water are fixed in the form of precipitates in accordance with reactions given by Expressions (2) to (4) below.

Ca²⁺+CO₃²⁻→CaCO₃↓ (2)

Sr²⁺+CO₃²⁻→SrCO₃↓ (3)

Mg²⁺+2OH⁻→Mg(OH)₂↓ (4)

In the case of performing alkali aggregation, an alkali metal carbonate such as sodium carbonate (Na₂CO₃) or potassium carbonate (K₂CO₃) is preferably used as the carbonate added to the raw water. These may be used alone or in combination. Alternatively, wastewater containing these carbonates can be used.

When the amount of the added carbonate is excessively small, Sr and other alkaline-earth metal ions in the raw water cannot be sufficiently removed. When the amount of the added carbonate is excessively large, any removal effect appropriate to the amount of the added carbonate is obtained. Therefore, the amount of the added carbonate is appropriately determined depending on the concentrations of Sr and the other alkaline-earth metal ions in the raw water so as to be consistent with the reaction equivalent. If the concentrations of Sr and the other alkaline-earth metal in the raw water are determined from above Expressions (2) to (4), then the necessary amount of the added carbonate can be calculated. However, the carbonate is preferably added in an amount equivalent to 1.0 to 2.0 times the theoretically necessary amount because a portion of the carbonate does not contribute to reaction.

Ca and Sr deposit under alkaline conditions at a pH of 9 to 13.5 in the form of CaCO₃ and SrCO₃, respectively, and therefore the raw water is adjusted to a pH of 9 to 13.5 by adding alkali such as sodium hydroxide (NaOH) or potassium hydroxide (KOH) as a pH adjustor. In particular, when the raw water contains Mg²⁺, the raw water is preferably adjusted to a pH of 12 to 13.5 because Mg²⁺ deposits in the form of Mg(OH)₂ at a pH of 12 or more. Incidentally, alkaline wastewater may be used as alkali used for pH adjustment.

Performing such alkali aggregation enables radioactive strontium and the alkaline-earth metal ions co-present therewith to be deposited in the form of carbonates and a hydroxide (in the case of magnesium) to reduce the concentration in the raw water.

In alkali aggregation, in order to obtain deposits by allowing Sr and the other alkaline-earth metal ions in the raw water to sufficiently react with the carbonate, the stirrer-equipped reaction tank is preferably designed such that a residence time (reaction time) of about 1 minute to 30 minutes is achieved.

In the case of performing alkali aggregation, a reaction solution may be subjected to aggregation treatment using a polymeric coagulant such as an anionic polymeric coagulant (anionic polymer).

That is, strontium carbonate and calcium carbonate form good aggregated flocs with excellent settleability and magnesium hydroxide, however, forms bulky flocs with poor settleability. Magnesium hydroxide has a slightly positive surface, therefore is formed into coarse flocs by adding an anionic polymer, and can be improved in settleability.

Examples of the anionic polymer include, but are not particularly limited to, partial hydrolysates of polyacrylamides; copolymers of polyacrylamides and sodium acrylate; copolymers of polyacrylamides and sodium vinylsulfonate; and ternary copolymers of polyacrylamides, sodium acrylate, and sodium 2-acrylamide-2-methylpropanesulfonate. These can be used alone or in combination.

When the amount of the added anionic polymer is excessively small, any sufficient aggregation effect is not obtained. When the amount of the added anionic polymer is excessively large, an aggregation failure may possibly be caused. Therefore, the amount of the added anionic polymer is preferably about 0.5 mg/L to 5 mg/L.

In the case of performing alkali aggregation, after solid-liquid separation is performed subsequently thereto, the powdery alkali metal titanate may be added. It is advantageous that after alkali aggregation is performed, the powdery alkali metal titanate is added without performing solid-liquid separation and solid-liquid separation is then performed, because the settling tank and MF membrane separator for solid-liquid separation can be integrated into one.

In the case of performing alkali aggregation, not only a mode that the powdery alkali metal titanate is added after alkali aggregation but also alkali aggregation and adsorption treatment using the powdery alkali metal titanate may be performed at the same time by adding the powdery alkali metal titanate together with a carbonate and alkali for pH adjustment. That is, radioactive strontium and the alkaline-earth metal ions react preferentially with the carbonate and therefore an object can be achieved even if the carbonate and the powdery alkali metal titanate are added at the same time.

It is preferred that after the concentrations of radioactive strontium and the alkaline-earth metal ions in the raw water are reduced in such a manner that the carbonate is added to the raw water and is subjected to reaction for a predetermined time under alkaline conditions, adsorption treatment is performed by adding the powdery alkali metal titanate, because the concentrations of radioactive strontium and the alkaline-earth metal ions can be sufficiently reduced to a level not higher than the solubility of a deposited precipitate. The pH of a treatment solution for alkali aggregation becomes a pH suitable for adsorption by the alkali metal titanate and adsorption treatment can be efficiently performed.

After the carbonate is added to the raw water, the alkali metal titanate may be added together with the alkali for pH adjustment during alkali aggregation.

The following apparatus is described below with reference to drawings: a treatment apparatus for radioactive strontium-containing wastewater according to the present invention, the treatment apparatus being used to carry out a treatment method for radioactive strontium-containing wastewater according to the present invention in combination with alkali aggregation.

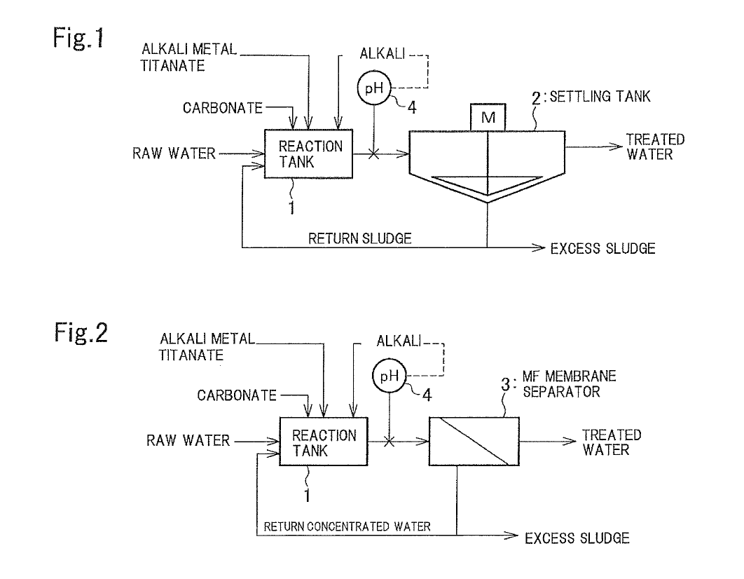

FIGS. 1 to 4 each show an example of an embodiment of the treatment apparatus, according to the present invention, for radioactive strontium-containing wastewater. Reference numerals 1, 1A, and 1B each represent a stirrer-equipped reaction tank, a reference numeral 2 represents a settling tank, a reference numeral 3 represents an MF membrane separator, and a reference numeral 4 represents a pH meter.

### 1) Single Reaction Tank+Settling Tank

The treatment apparatus, shown in FIG. 1, for radioactive strontium-containing wastewater includes the single stirrer-equipped reaction tank 1 and the settling tank 2. The raw water is introduced into the reaction tank 1; the alkali metal titanate (powder or slurry), the carbonate, and the alkali for pH adjustment are added to the reaction tank 1 in synchronization with the pH meter 4 and are subjected to reaction for a predetermined time; and a reaction solution coming from the reaction tank 1 is subjected to solid-liquid separation in the settling tank 2. Separated water in the settling tank 2 is discharged outside in the form of treated water, a portion of separated sludge is returned to the reaction tank 1 as return sludge, and the remainder is discharged outside in the form of excess sludge.

The effect of coarsening deposits using the return sludge as a nucleus to enhance the settleability is achieved by performing sludge returning. However, performing sludge returning leads to the scale-up of a treatment system; hence, sludge returning need not be performed.

### 2) Single Reaction Tank+MF Membrane Separator

The treatment apparatus, shown in FIG. 2, for radioactive strontium-containing wastewater includes the single stirrer-equipped reaction tank 1 and the MF membrane separator 3. As is the case in FIG. 1, the raw water is introduced into the reaction tank 1; the alkali metal titanate (powder or slurry), the carbonate, and the alkali for pH adjustment are added to the reaction tank 1 in synchronization with the pH meter 4 and are subjected to reaction for a predetermined time; and a reaction solution coming from the reaction tank 1 is subjected to solid-liquid separation in the MF membrane separator 3. Permeable water in the MF membrane separator 3 is discharged outside in the form of treated water, a portion of concentrated water is returned to the reaction tank 1 in the form of returned concentrated water, and the remainder is discharged outside in the form of excess sludge.

In a mode shown in FIG. 2, the effect of coarsening deposits using solid matter in the concentrated water as a nucleus to enhance the solid-liquid separability is achieved by returning the concentrated water. However, returning the concentrated water leads to the scale-up of a treatment system; hence, the concentrated water need not be returned.

### 3) Two Reaction Tanks+Settling Tank

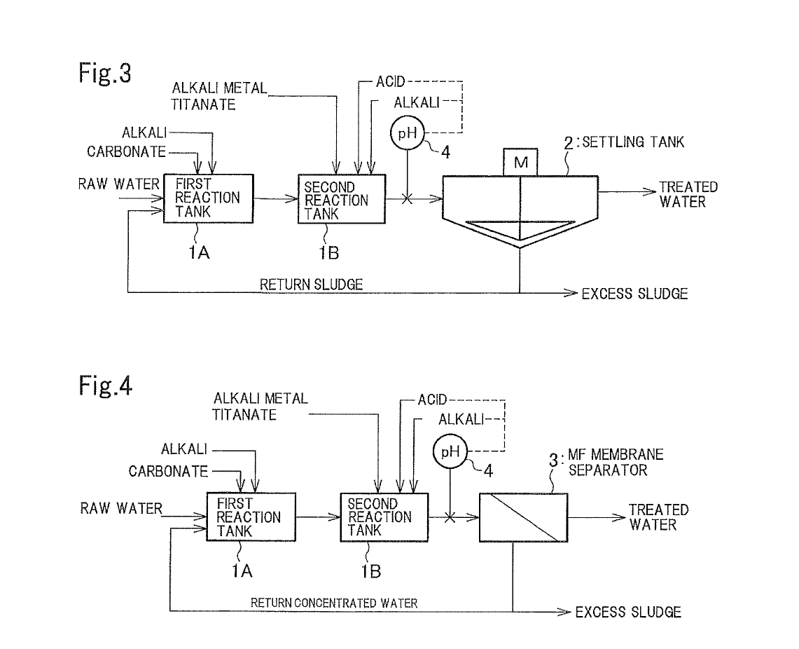

The treatment apparatus, shown in FIG. 3, for radioactive strontium-containing wastewater includes the two stirrer-equipped reaction tanks 1A and 1B and the settling tank 2. The raw water is introduced into the first reaction tank 1A, the carbonate and the alkali for pH adjustment are added to the first reaction tank 1A and are subjected to reaction for a predetermined time, a reaction solution in the first reaction tank 1A is supplied to the second reaction tank 1B, and the alkali metal titanate (powder or slurry) and acid or alkali for pH adjustment are added to the second reaction tank 1B in synchronization with the pH meter 4 and are subjected to reaction for a predetermined time. A reaction solution coming from the second reaction tank 1B is subjected to solid-liquid separation in the settling tank 2. Separated water in the settling tank 2 is discharged outside in the form of treated water, a portion of separated sludge is returned to the first reaction tank 1A as return sludge, and the remainder is discharged outside in the form of excess sludge.

In a mode shown in FIG. 3, the effect of coarsening deposits using the return sludge as a nucleus to enhance the settleability is achieved by performing sludge returning. However, performing sludge returning leads to the scale-up of a treatment system; hence, sludge returning need not be performed.

### 4) Two Reaction Tanks+MF Membrane Separator

The treatment apparatus, shown in FIG. 4, for radioactive strontium-containing wastewater includes the two stirrer-equipped reaction tanks 1A and 1B and the MF membrane separator 3. The raw water is introduced into the first reaction tank 1A, the carbonate and the alkali for pH adjustment are added to the first reaction tank 1A and are subjected to reaction for a predetermined time, a reaction solution in the first reaction tank 1A is supplied to the second reaction tank 1B, and the alkali metal titanate (powder or slurry) and acid or alkali for pH adjustment are added to the second reaction tank 1B in synchronization with the pH meter 4 and are subjected to reaction for a predetermined time. A reaction solution coming from the second reaction tank 1B is subjected to solid-liquid separation in the MF membrane separator 3. Permeable water in the MF membrane separator 3 is discharged outside in the form of treated water, a portion of concentrated water is return to the first reaction tank 1A as return sludge, and the remainder is discharged outside in the form of excess sludge.

In a mode shown in FIG. 4, the effect of coarsening deposits using solid matter in the concentrated water as a nucleus to enhance the solid-liquid separability is achieved by returning the concentrated water. However, returning the concentrated water leads to the scale-up of a treatment system; hence, the concentrated water need not be returned.

### Examples

The present invention is further described below in detail with reference to examples and a comparative example.

In the examples and the comparative example below, simulated seawater with properties shown in Table 1 below was used as raw water.

TABLE 1

| | pH | Conductivity | Ca | Mg | Sr |
|---|---|---|---|---|---|
| Appearance | [—] | [mS/m] | [mg/L] | [mg/L] | [mg/L] |
| Colorless | 8.2 | 4,880 | 407 | 1407 | 6.8 |
| and transparent | | | | | |

### Synthetic Example 1

### Synthesis of Potassium Dititanate

In a Henschel mixer, 418.94 g of titanium oxide and 377.05 g of potassium carbonate were mixed. An obtained mixture was mixed for 0.5 hours in a vibration mill while being crushed.

Fifty grams of an obtained crashed mixture was filled in a crucible and was calcined at 780° C. for 4 hours in an electric furnace. A calcined product was crushed in a hammer mill, whereby potassium dititanate having such a shape that a plurality of bumps extended in irregular directions was obtained. The average particle size thereof was 20 μm.

### Comparative Example 1

Na₂CO₃ was added to raw water so as to become 1,300 mg/L at its concentration. The pH thereof was adjusted to 12.5 using NaOH. In this operation, the concentration of deposited sludge was about 2% by weight. The raw water was then subjected to solid-liquid separation using an MF membrane with a pore size of 0.2 μm, whereby treated water (water permeated through the MF membrane) was obtained. The quality of the treated water was as shown in Table 2.

### Examples 1 to 6

In Comparative Example 1, powdery potassium dititanate obtained in Synthetic Example 1 was added together with Na₂CO₃ and NaOH such that the amount of added potassium titanate was 200 mg/L or 500 mg/L, followed by reaction for a time shown in Table 2 in a stirrer-equipped reaction tank. Thereafter, a reaction solution was subjected to MF membrane separation treatment as is the case in Comparative Example 1. The quality of obtained treated water was as shown in Table 2.

### Examples 7 and 8

In Comparative Example 5 and 6, slurry (10% by weight powdery potassium dititanate) prepared by suspending powdery potassium dititanate obtained in Synthetic Example 1 in a 0.1 mol/L KCl solution was added such that the amount of added potassium titanate was 500 mg/L, followed by reaction for a time shown in Table 2 in a stirrer-equipped reaction tank. Thereafter, a reaction solution was subjected to MF membrane separation treatment as is the case in Comparative Examples 5 and 6. The quality of obtained treated water was as shown in Table 2.

TABLE 2

| | Amount of added | Reaction | Treated water | | |
|---|---|---|---|---|---|
| | potassium titanate | time | Sr | Ca | Mg |
| | mg/L | (minute) | mg/L | mg/L | mg/L |
| Comparative | 0 | — | 1.33 | 0.71 | <0.1 |
| Example 1 | | | | | |
| Example 1 | 200 | 10 | 0.754 | — | — |
| Example 2 | 200 | 30 | 0.489 | — | — |
| Example 3 | 200 | 60 | 0.435 | 0.67 | <0.1 |
| Example 4 | 200 | 120 | 0.38 | 0.76 | 0.12 |
| Example 5 | 500 | 10 | 0.396 | — | — |
| Example 6 | 500 | 120 | 0.081 | 0.77 | <0.1 |
| Example 7 | 500 | 10 | 0.381 | — | — |
| Example 8 | 500 | 120 | 0.078 | 0.69 | <0.1 |

Table 2 shows clearly that, according to the present invention, the radiation dose of treated water can be effectively reduced in such a manner that radioactive strontium is efficiently removed even from high-concentration radioactive strontium-containing wastewater in which other alkaline-earth metal ions are co-present.

The present invention has been described in detail using specific embodiments. It is apparent to those skilled in the art that various modifications can be made without departing from the spirit and scope of the present invention.

The application is based on Japanese Patent Application 2012-122214 filed on May 29, 2012, the entirety of which is incorporated herein by reference.

### REFERENCE SIGNS LIST

1, 1A, 1B Reaction tank
2 Settling tank
3 MF membrane separator
4 pH meter

1. A method for treating radioactive strontium-containing wastewater, comprising:
a step of mixing wastewater containing radioactive strontium with a powdery alkali metal titanate in a stirrer-equipped reaction tank to allow the powdery alkali metal titanate to adsorb radioactive strontium in the wastewater; and
a step of subjecting the powdery alkali metal titanate on which radioactive strontium is adsorbed to solid-liquid separation.

2. The method for treating radioactive strontium-containing wastewater according to claim 1, wherein an alkali metal of the powdery alkali metal titanate is sodium and/or potassium.

3. The method for treating radioactive strontium-containing wastewater according to claim 1, wherein the powdery alkali metal titanate has an average particle size of 1 μm to 1,000 μm, and has a non-fibrous in which a plurality of bumps having a round tip extend in irregular directions.

4. The method for treating radioactive strontium-containing wastewater according to claim 1, wherein the powdery alkali metal titanate is used in the form of slurry.

5. The method for treating for radioactive strontium-containing wastewater according to claim 1,
wherein the method further comprises an alkali aggregation step for depositing strontium in the wastewater in such a manner that carbonate ions are added to the wastewater in an amount equivalent to 1.0 to 2.0 times the amount of strontium contained in the wastewater, and alkali is then further added to the wastewater such that the pH thereof is adjusted to 9.0 to 13.5; and
wherein the powdery alkali metal titanate is added during the alkali aggregation step or after the alkali aggregation step.

6. The method for treating radioactive strontium-containing wastewater according to claim 1, wherein the wastewater contains an alkaline-earth metal other than strontium,
wherein the method further comprises an alkali aggregation step for depositing strontium and the alkaline-earth metal other than strontium in the wastewater in the form of carbonates or hydroxides in such a manner that carbonate ions are added in an amount equivalent to 1.0 to 2.0 times the amount of all the alkaline-earth metals in the wastewater, and alkali is further added such that the pH thereof is adjusted to 9.0 to 13.5; and
wherein the powdery alkali metal titanate is added during the alkali aggregation step or after the alkali aggregation step.

7. An apparatus for treating radioactive strontium-containing wastewater, comprising:
a stirrer-equipped reaction tank;
means for introducing radioactive strontium-containing wastewater into the reaction tank;
means for adding a powdery alkali metal titanate to the reaction tank; and
solid-liquid separation means for subjecting a reaction solution coming from the reaction tank to solid-liquid separation,
wherein the powdery alkali metal titanate is added to the radioactive strontium-containing wastewater in the reaction tank, radioactive strontium in the wastewater is adsorbed on the powdery alkali metal titanate, and the powdery alkali metal titanate having radioactive strontium adsorbed thereon is separated with the solid-liquid separation means.

8. The apparatus for treating radioactive strontium-containing wastewater according to claim 7,
wherein the apparatus further comprises means for adding a carbonate to the reaction tank and means for adjusting the pH in the reaction tank.

9. The treatment apparatus for radioactive strontium-containing wastewater according to claim 7,
wherein the apparatus further comprises a first reaction tank in which a carbonate and alkali are added to the wastewater, the first reaction tank being located upstream of the stirrer-equipped reaction tank so that an outflow from the first reaction tank is introduced into the stirrer-equipped reaction tank.

10. The apparatus for treating radioactive strontium-containing wastewater according to claim 7, wherein the solid-liquid separation means is a settling tank or an ultrafiltration membrane separator.
